(19) United States
(12) Patent Application Publication
(10) Pub. No.: US 2016/0094059 A1
(43) Pub. Date: Mar. 31, 2016

(54) CHARGING/DISCHARGING CONTROL DEVICE AND BATTERY DEVICE

(71) Applicant: Seiko Instruments Inc., Chiba-shi (JP)

(72) Inventor: Fumihiko MAETANI, Chiba-shi (JP)

(21) Appl. No.: 14/862,639

(22) Filed: Sep. 23, 2015

(30) Foreign Application Priority Data
Sep. 25, 2014 (JP) 2014-195699

(51) Int. Cl. H02J 7/00

(52) U.S. Cl. CPC H02J 7/007; H02J 7/0031; H02J 2007/0037

(57) ABSTRACT

To provide a battery device which blows out a fuse element as a protective element only when overcharging and overcurrent of a secondary battery are detected, and prevents false blowing. The absolute value of a threshold voltage to turn ON a control switch connected to a heating resistor for blowing out the fuse element is set to be equal to or greater than a minimum operating voltage of an overcharge detection circuit and less than an overcharge detection voltage thereof.

### RELATED APPLICATIONS

This application claims priority under 35 U.S.C. §119 to Japanese Patent Application No. 2014-195699 filed on Sep. 25, 2014, the entire content of which is hereby incorporated by reference.

### BACKGROUND OF THE INVENTION

1. Field of the Invention

The present invention relates to a charging/discharging control device and a battery device which prevent overcharging and overcurrent of a battery pack using a protective element provided with a heating resistor and a fuse element.

2. Description of the Related Art

With the diffusion of mobile electronic devices such as a cellular phone, a notebook personal computer, etc., the market of a lithium ion secondary battery has been expanded. In these mobile electronic devices, a battery pack having one to plural lithium ion secondary batteries connected in series has normally been used as a power supply. Such a battery pack is provided with a charging/discharging control device to protect each lithium ion secondary battery.

The charging/discharging control device protects the lithium ion secondary battery from both of overcurrent and overcharging. The charging/discharging control device is comprised of a protective element having a heating resistor and a fuse element, an overcharge detection circuit which detects the overcharging, and a control switch which causes current to flow through the heating resistor of the protective element. The charging/discharging control device blows out the fuse element at overcurrent and thereby protects the secondary battery from the overcurrent. During overcharging, the overcharge detection circuit detects the overcharging of the secondary battery and turns ON the control switch. Then, the current is made to flow through the heating resistor to blow out the fuse element by heat generated thereat, thereby protecting the secondary battery from overcharging (refer to Patent Document 1).

[Patent Document 1] Japanese Patent Application Laid-Open No. 2008-263776

### SUMMARY OF THE INVENTION

Recently, there have been increasing devices such as a smart phone, a tablet terminal, etc. which are driven by a high voltage and high capacity lithium ion secondary battery. A charging/discharging control device using a protective element provided with a heating resistor and a fuse element is used to protect a battery pack for these devices against overcurrent and overcharging.

In a related art, however, there is a case where when a battery device is assembled or when discharging of a lithium ion secondary battery progresses and hence an output voltage is reduced, a power supply voltage enough for an overcharge detection circuit to operate cannot be secured, and the output of the overcharge detection circuit becomes unstable.

Originally, the control switch should be turned ON only when the secondary battery becomes overcharged, but is not able to perform a desired operation if a voltage enough for the overcharge detection circuit to be able to operate is not applied. The voltage enough for the overcharge detection circuit to be able to operate is referred to as a minimum operating voltage. When the voltage to be applied is less than the minimum operating voltage, the output voltage of the overcharge detection circuit becomes unstable. Thus, it is not possible to ensure whether to turn ON or OFF the control switch.

A step of connecting the secondary battery to the charging/discharging control device exists upon assembling the battery device. At this time, the voltage is raised up to the voltage of the secondary battery from a state in which no voltage is applied to the overcharge detection circuit. When the voltage to be applied is less than the minimum operating voltage, the overcharge detection circuit is in danger of turning ON the control switch to blow out the fuse element.

Further, even when the discharging of the secondary battery proceeds and the output voltage of the secondary battery falls below the minimum operating voltage of the overcharge detection circuit, there is a possibility that the control switch will be turned ON to blow out the fuse element.

When the fuse element is blown out, the battery device cannot be used again. Therefore, a mechanism provided to protect the lithium ion secondary battery from its overcharging is operated in the case other than the above to disable the battery device.

The present invention has been invented to solve the above-mentioned problems. It is an object of the present invention to provide a charging/discharging control device and a battery device which cause no turning on of a control switch and have no fear of blowing out a fuse element even if the output of an overcharge detection circuit becomes unstable.

In order to solve the related art problems, the present invention uses a switch having a threshold voltage higher than a voltage at which the output of an overcharge detection circuit becomes unstable, as a control switch of a charging/discharging control device.

According to the present invention, there can be provided a charging/discharging control device and a battery device which cause no turning on of a control switch of the charging/discharging control device and have no fear of blowing out a fuse element even if the output of an overcharge detection circuit becomes unstable when assembling the battery device and when discharging of a lithium ion secondary battery proceeds and an output voltage is reduced.

### BRIEF DESCRIPTION OF THE DRAWINGS

FIG. 1 is a circuit diagram of a battery device of a first embodiment;

FIG. 2 is a circuit diagram of a battery device of a second embodiment;

FIG. 3 is a circuit diagram of a battery device of a third embodiment; and

FIG. 4 is a circuit diagram of a battery device of a fourth embodiment.

### DETAILED DESCRIPTION OF THE PREFERRED EMBODIMENTS

Preferred embodiments will hereinafter be described with reference to the accompanying drawings.

### First Embodiment

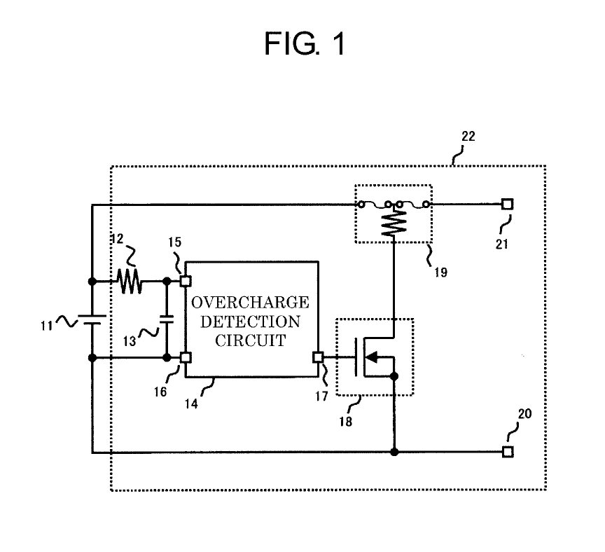

FIG. 1 is a circuit diagram of a battery device of a first embodiment. The battery device of the first embodiment is comprised of a secondary battery 11 and a charging/discharging control device 22. The charging/discharging control device 22 is comprised of a resistor 12, a capacitor 13, an overcharge detection circuit 14, a control switch 18, a protective element 19, and external terminals 20 and 21.

The protective element 19 is provided with a heating resistor and a fuse element and configured in such a manner that the heating resistor is energized to generate heat thereby to blow out the fuse element.

The overcharge detection circuit 14 has a positive electrode power supply terminal 15 and a negative electrode power supply terminal 16 as input terminals and outputs a positive electrode power supply terminal potential or a negative electrode power supply terminal potential from an output terminal 17.

The secondary battery 11 has a positive electrode connected to one terminals of the fuse element of the protective element 19 and the resistor 12, and a negative electrode connected to one terminal of the capacitor 13, the negative electrode power supply terminal 16, a source and a back gate of the control switch 18, and the external terminal 20. The other terminal of the fuse element of the protective element 19 is connected to the external terminal 21. The positive electrode power supply terminal 15 is connected to a connection point of the other terminals of the resistor 12 and the capacitor 13. The output terminal 17 is connected to a gate of the control switch 18, and a drain of the control switch 18 is connected to the heating resistor of the protective element 19.

The operation of the battery device of the first embodiment will next be described.

When the voltage of the secondary battery 11 is less than an overcharge detection voltage set by the overcharge detection circuit 14, the overcharge detection circuit 14 outputs the negative electrode power supply terminal potential from the output terminal 17 to turn OFF the control switch 18. In this case, if a load or a charger is connected between the external terminals 20 and 21, current can be made to flow therethrough to bring about a chargeable/dischargeable state.

When a load small in resistance value is connected between the external terminals 20 and 21 and a current larger than an overcurrent value set by the protective element 19 is made to flow therethrough, the fuse element of the protective element 19 is blown out to protect the secondary battery 11 from overcurrent.

When a charger is connected between the external terminals 20 and 21, and abnormal charging proceeds so that the overcharge detection circuit 14 detects overcharging of the secondary battery 11, the overcharge detection circuit 14 outputs the positive electrode power supply terminal potential from the output terminal 17 to turn ON the control switch 18. Then, current is made to flow through the heating resistor of the protective element 19 to blow out the fuse element of the protective element 19 by heat generated thereat, thereby protecting the secondary battery 11 from overcharging.

In the present invention, the threshold voltage to turn ON the control switch 18 is set sufficiently higher than the minimum operating voltage of the overcharge detection circuit 14. Doing this makes the control switch 18 unable to turn ON even if the overcharge detection circuit 14 outputs a positive electrode terminal potential at the minimum operating voltage or less. It is desirable that the control switch 18 is turned ON only when the overcharge detection circuit 14 has detected the overcharging. Thus, the threshold voltage of the control switch 18 is preferably set to a voltage as high as possible at equal to or greater than the minimum operating voltage of the overcharge detection circuit 14 and less than the overcharge detection voltage set by the overcharge detection circuit 14.

As described above, there can be provided a charging/discharging control device and a battery device which cause no turning on of the control switch 18 and have no fear of blowing out the fuse element of the protective element 19 by setting the threshold voltage to turn ON the control switch 18 to the voltage as high as possible at equal to or greater than the minimum operating voltage of the overcharge detection circuit 14 and less than the overcharge detection voltage thereof.

### Second Embodiment

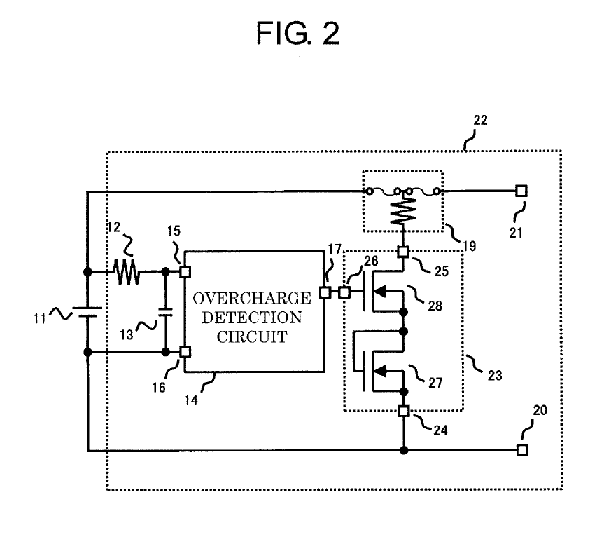

FIG. 2 is a circuit diagram of a battery device of a second embodiment. The battery device of the second embodiment is different from the battery device of the first embodiment in that field effect transistors are stacked on each other in a multistage manner as in a control switch 23.

The control switch 23 is comprised of Nch field effect transistors 27 and 28, an input terminal 26, a negative electrode power supply terminal 24, and an output terminal 25. The negative electrode power supply terminal 24 is connected to a source and a back gate of the Nch field effect transistor 27. A gate of the Nch field effect transistor 27 is connected to a drain of the Nch field effect transistor 27 and a source and a back gate of the Nch field effect transistor 28. A gate of the Nch field effect transistor 28 is connected to the input terminal 26, and a drain thereof is connected to the output terminal 25.

By configuring the control switch 23 as described above, the threshold voltage to turn ON the control switch 23 results in combining a threshold voltage to turn ON the Nch field effect transistor 27 and a threshold voltage to turn ON the Nch field effect transistor 28. Further, the threshold voltage to turn ON the control switch 23 becomes higher than the combination of the threshold voltage to turn ON the Nch field effect transistor 27 and the threshold voltage to turn ON the Nch field effect transistor 28 by connecting the back gate of the Nch field effect transistor 28 to the negative electrode power supply terminal 24. Although the control switch 23 is configured by the two Nch field effect transistors as an example, any number of Nch field effect transistors each having such a connection as to be done by the Nch field effect transistor 27 can be set, and the threshold voltage can be raised by increasing the number of connections in series.

As described above, there can be provided a charging/discharging control device and a battery device which cause no turning on of the control switch 23 and have no fear of blowing out the fuse element of the protective element 19 by setting the threshold voltage to turn ON the control switch 23 to the voltage as high as possible at equal to or greater than the minimum operating voltage of the overcharge detection circuit 14 and less than the overcharge detection voltage thereof.

### Third Embodiment

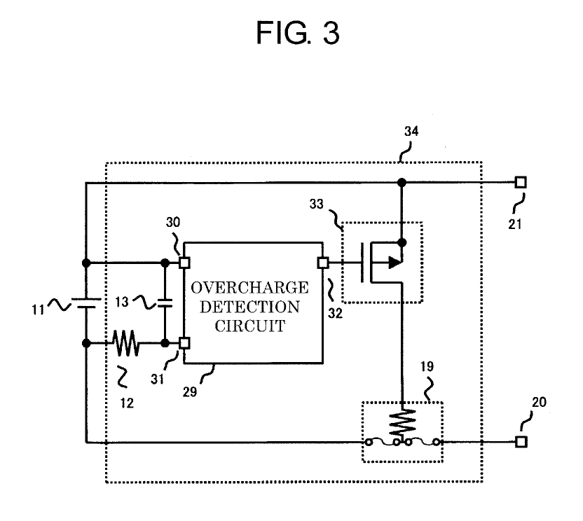

FIG. 3 is a circuit diagram of a battery device of a third embodiment.

The battery device of the third embodiment is comprised of a secondary battery 11 and a charging/discharging control device 34. The charging/discharging control device 34 is comprised of a resistor 12, a capacitor 13, an overcharge detection circuit 29, a control switch 33, a protective element 19 provided with a heating resistor and a fuse element and configured to blow out the fuse element by current-carrying and heating the heating resistor, and external terminals 20 and 21.

The overcharge detection circuit 29 has a positive electrode power supply terminal 30 and a negative electrode power supply terminal 31 as input terminals and outputs a positive electrode power supply terminal potential or a negative electrode power supply terminal potential from an output terminal 32.

The secondary battery 11 has a negative electrode connected to one terminals of the fuse element of the protective element 19 and the resistor 12, and a positive electrode connected to one terminal of the capacitor 13, the positive electrode power supply terminal 30, a source and a back gate of the control switch 33, and the external terminal 21. The other terminal of the fuse element of the protective element 19 is connected to the external terminal 20. The negative electrode power supply terminal 31 is connected to the other terminals of the resistor 12 and the capacitor 13. The output terminal 32 is connected to a gate of the control switch 33, and a drain of the control switch 33 is connected to the heating resistor of the protective element 19.

The operation of the battery device of the third embodiment will next be described.

When the voltage of the secondary battery 11 is less than or equal to an overcharge detection voltage set by the overcharge detection circuit 29, the overcharge detection circuit 29 outputs the positive electrode power supply terminal potential from the output terminal 32 to turn OFF the control switch 33. In this case, if a load or a charger is connected between the external terminals 20 and 21, current can be made to flow therethrough to bring about a chargeable/dischargeable state.

When a load small in resistance value is connected between the external terminals 20 and 21 and a current larger than an overcurrent value set by the protective element 19 is made to flow therethrough, the fuse element of the protective element 19 is blown out to protect the secondary battery 11 from overcurrent.

When a charger is connected between the external terminals 20 and 21, and abnormal charging proceeds so that the overcharge detection circuit 29 detects overcharging of the secondary battery 11, the overcharge detection circuit 29 outputs the negative electrode power supply terminal potential from the output terminal 32 to turn ON the control switch 33. Then, current is made to flow through the heating resistor of the protective element 19 to blow out the fuse element of the protective element 19 by heat generated thereat, thereby protecting the secondary battery 11 from overcharging.

In the present invention, the absolute value of the threshold voltage to turn ON the control switch 33 is set sufficiently higher than the minimum operating voltage of the overcharge detection circuit 29. Doing this makes the control switch 33 unable to turn ON even if the overcharge detection circuit 29 outputs a negative electrode terminal potential at less than the minimum operating voltage. It is desirable that the control switch 33 is turned ON only when the overcharge detection circuit 29 has detected the overcharging. Thus, the absolute value of the threshold voltage of the control switch 33 is preferably set to a voltage as high as possible at equal to or greater than the minimum operating voltage of the overcharge detection circuit 29 and less than the overcharge detection voltage set by the overcharge detection circuit 29.

As described above, there can be provided a charging/discharging control device and a battery device which cause no turning on of the control switch 33 and have no fear of blowing out the fuse element of the protective element 19 by setting the threshold voltage to turn ON the control switch 33 to the voltage as high as possible at equal to or greater than the minimum operating voltage of the overcharge detection circuit 29 and less than the overcharge detection voltage thereof.

### Fourth Embodiment

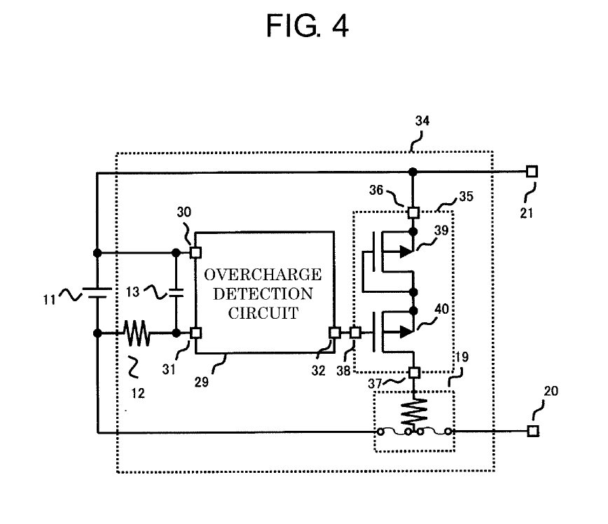

FIG. 4 is a circuit diagram of a battery device of a fourth embodiment. The battery device of the fourth embodiment is different from the battery device of the third embodiment in that field effect transistors are stacked on each other in a multistage manner as in a control switch 35.

The control switch 35 is comprised of Pch field effect transistors 39 and 40, an input terminal 38, a positive electrode power supply terminal 36, and an output terminal 37. The positive electrode power supply terminal 36 is connected to a source and a back gate of the Pch field effect transistor 39. A gate of the Pch field effect transistor 40 is connected to a drain of the Pch field effect transistor 39 and a source and a back gate of the Pch field effect transistor 40. A gate of the Pch field effect transistor 40 is connected to the input terminal 38, and a drain thereof is connected to the output terminal 37.

By configuring the control switch 35 as described above, the threshold voltage to turn ON the control switch 35 results in combining a threshold voltage to turn ON the Pch field effect transistor 39 and a threshold voltage to turn ON the Pch field effect transistor 40. Further, the threshold voltage to turn ON the control switch 35 becomes higher than the combination of the threshold voltage to turn ON the Pch field effect transistor 39 and the threshold voltage to turn ON the Pch field effect transistor 40 by connecting the back gate of the Pch field effect transistor 40 to the positive electrode power supply terminal 36. Although the control switch 35 is configured by the two Pch field effect transistors as an example, any number of Pch field effect transistors each having such a connection as to be done by the Pch field effect transistor 39 can be set, and the absolute value of the threshold voltage can be raised by increasing the number of connections in series.

As described above, there can be provided a charging/discharging control device and a battery device which cause no turning on of the control switch 35 and have no fear of blowing out the fuse element of the protective element 19 by setting the absolute value of the threshold voltage to turn ON the control switch 35 to the voltage as high as possible at equal to or greater than the minimum operating voltage of the overcharge detection circuit 29 and less than the overcharge detection voltage thereof.

What is claimed is:

1. A charging/discharging control device protecting a secondary battery, comprising:
an overcharge detection circuit configured to detect overcharging;
a protective element provided with a heating resistor and a fuse element; and
a control switch configured to allow a current to flow through the heating resistor when the overcharge detection circuit detects the overcharging,
the absolute value of a threshold voltage to turn ON the control switch being equal to or greater than a minimum operating voltage of the overcharge detection circuit and less than an overcharge detection voltage.

2. A battery device comprising:
a secondary battery; and
a charging/discharging control device according to claim 1.
